(19) United States
(12) Patent Application Publication
(10) Pub. No.: US 2013/0184375 A1
(43) Pub. Date: Jul. 18, 2013

(54) RUBBER MODIFIED ACRYLIC RESIN COMPOSITION EXCELLENT IN JET-BLACKNESS AND MOLDED PRODUCT THEREOF

(71) Applicants: Taizo Aoyama, Osaka (JP); Tetsuo Mekata, Osaka (JP); Yutaka Kaneda, Osaka (JP)

(72) Inventors: Taizo Aoyama, Osaka (JP); Tetsuo Mekata, Osaka (JP); Yutaka Kaneda, Osaka (JP)

(73) Assignee: KANEKA CORPORATION, Osaka (JP)

(21) Appl. No.: 13/350,148

(22) Filed: Jan. 13, 2012

(51) Int. Cl. C08L 19/00; C08K 3/04; B29C 45/00

(52) U.S. Cl. 523/220; 264/328.1; 524/496

(57) ABSTRACT

A jet-black rubber modified acrylic resin composition comprising:
a rubber modified acrylic resin (A); and
a carbon black (B) blended with the resin (A),
the rubber modified acrylic resin (A) being capable of providing a 3-mm-thick molded product that has transparency with a total light transmittance of 85% or higher, and
the carbon black being dispersed in the resin composition and having a particle diameter of 10 to 40 nm.

### FIELD OF THE INVENTION

The present invention relates to a rubber modified acrylic resin composition excellent not only in weather resistance, impact resistance, appearance and mold-processability, but also in jet-blackness, and a molded product prepared from the resin composition.

### DESCRIPTION OF THE RELATED ART

Acrylic resin mainly containing polymethyl methacrylate is excellent in weather resistance, gloss, and transparency, but there is no resin which can simultaneously satisfy impact resistance, weather resistance and jet-blackness. Thus, acrylic resin has limited uses.

In order to impart impact resistance to such methacrylic resin while maintaining the excellent weather resistance of the resin, methods of mixing various multilayer graft copolymers are proposed. Typical methods (a), (b), and (c) are summarized below.

The below-mentioned weather resistance, gloss, impact resistance, and processability are characteristics of methacrylic resin alone or a methacrylic resin composition obtainable by mixing a graft copolymer into methacrylic resin.

(a) In order to impart impact resistance to methacrylic resin while maintaining its excellent weather resistance, there has been proposed a method including: mixing into a methacrylic resin a graft copolymer having a rubbery polymer/hard polymer bilayer structure, which is obtained by polymerizing a monomer component such as alkyl methacrylate which can be a constitutional unit of a relatively hard polymer with a glass transition temperature of not lower than room temperature (hereinafter, referred to as a hard monomer component) with a rubbery polymer which mainly contains an alkyl acrylate having excellent weather resistance and which has a glass transition temperature of not higher than room temperature (Patent Documents 1 and 2).

(b) There has also been proposed a method including: forming a rubbery polymer layer mainly containing an alkyl acrylate on the surface of a hard polymer shell containing 70 to 100% (% by weight, the same applies to the following) of a hard monomer component (e.g. alkyl methacrylate); graft-polymerizing a hard monomer component (e.g. alkyl methacrylate) to the surface of the rubbery polymer layer to prepare a graft copolymer having a hard polymer/rubbery polymer/hard polymer three-layer structure; and mixing the graft copolymer into methacrylic resin (Patent Document 3).

(c) There has also been proposed a method including: copolymerizing 35 to 45% of an alkyl acrylate with the hard monomer component (e.g. alkyl methacrylate), which is the innermost layer in the method (b), with a crosslinkable monomer having at least two functional groups selected from the group consisting of acryloyloxy groups and methacryloyloxy groups in one molecule thereof to form a semi-rubbery polymer whose glass transition temperature is made to be close to room temperature; forming a rubbery polymer layer mainly containing an alkyl acrylate on the surface of the semi-rubbery polymer shell; graft-polymerizing a hard monomer component (e.g. alkyl methacrylate) to the surface of the obtained shell to prepare a graft copolymer having a three-layer structure of semi-rubbery polymer/rubbery polymer/hard polymer; and mixing the graft copolymer into methacrylic resin (Patent Document 4).

Further, a jet-black composition is disclosed which contains a thermosetting acrylic resin and a 1:2 chromium complex of a mono-azo dye substituted with amino-phenol and coupled with 2-naphthol (Patent Document 5). However, the dye has a problem of light resistance.
Patent Document 1: U.S. Pat. No. 3,808,180
Patent Document 2: U.S. Pat. No. 3,843,753
Patent Document 3: U.S. Pat. No. 3,793,402
Patent Document 4: Japanese Patent Application Publication 62-230841
Patent Document 5: Japanese Patent Application Second Publication 6-089279

The disclosure of the respective related art documents is incorporated herein by reference.

### SUMMARY OF THE INVENTION

The present invention aims to provide a rubber modified acrylic resin composition excellent in weather resistance, gloss, jet-blackness, impact resistance, and processability, and a molded product prepared from the resin composition.

The present inventors have found that, as mentioned in Patent Document 5, it is difficult to obtain an acrylic resin excellent in jet-blackness and weather resistance by blending a dye such as an azo compound use for jet-blackness because the weather resistance of the dye itself and the weather resistance of a base resin affected by the dye are reduced. In order to solve the above problem, the present inventors have found carbon black as a jet-black material which less affects its own light resistance and the base resin, and have performed studies on a method for achieving excellent jet-blackness in the combination of the carbon black and an acrylic resin. As a result, the inventors have found that the problem can be solved by blending carbon black in a transparent rubber modified acrylic resin and dispersing the carbon black into a resin composition such that the particle diameter of the carbon black is 10 to 40 nm. Finally, the inventors have completed the present invention.

The present invention relates to a jet-black rubber modified acrylic resin composition comprising: a rubber modified acrylic resin (A); and a carbon black (B) blended with the resin (A), the rubber modified acrylic resin (A) being capable of providing a 3-mm-thick molded product that has transparency with a total light transmittance of 85% or higher, and the carbon black being dispersed in the resin composition and having a particle diameter of 10 to 40 nm.

In one preferable embodiment, the rubber modified acrylic resin composition is such that: 100 parts by weight of the rubber modified acrylic resin (A) contains 5 to 100 parts by weight of a rubber-containing acrylic graft copolymer (A1) and 95 to 0 parts by weight of an acrylic resin (A2); the rubber-containing acrylic graft copolymer (A1) is a multilayer graft copolymer having an inner layer of a rubber copolymer (A1c) and an outer layer of a graft component (A1s) with a weight ratio (A1c:A1s) of 5:95 to 85:15, the outer layer covering the inner layer; the rubber copolymer (A1c) is a polymer of 100% by weight of monomers for rubber copolymer containing 50 to 99.9% by weight of an alkyl acrylate, 0 to 49.9% by weight of another copolymerizable vinyl monomer, and 0.1 to 10% by weight of a polyfunctional monomer; the graft component (A1s) is a polymer of 100% by weight of monomers for graft component containing 50 to 100% by weight of an alkyl methacrylate and 0 to 50% by weight of a copolymerizable vinyl monomer other than the alkyl methacrylate; and the acrylic resin (A2) is a polymer of monomers for acrylic resin containing 0 to 50% by weight of an alkyl acrylate and 100 to 50% by weight of an alkyl methacrylate.

As mentioned above, the composition of the present invention preferably contains a specific amount of a specific rubber-containing acrylic graft copolymer which is well dispersed in a base resin, as well as the carbon black of the present invention, and which has excellent effects of imparting transparency and impact resistance. Thus, the composition is excellent not only in light resistance but also in water resistance because the possibility of hydrolysis of the base resin is reduced.

In one preferable embodiment, the rubber-containing acrylic graft copolymer (A1) has a number average particle diameter of 30 to 400 nm.

In one preferable embodiment, the rubber modified acrylic resin composition is such that: the rubber-containing acrylic graft copolymer (A1) is a multilayer graft copolymer which has at least three layers, which further has an innermost layer polymer (A1a) with a weight ratio (A1a:(sum of A1c and A1s)) of 10:90 to 40:60, and which is obtained by polymerization of the monomers for rubber copolymer in the presence of the innermost layer polymer (A1a); and the innermost layer polymer (A1a) is a polymer of 100% by weight of monomers for innermost layer polymer containing 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer.

The present invention also relates to a molded product prepared by molding the rubber modified acrylic resin composition of the present invention.

In one preferable embodiment, the molded product formed into a plate shape by injection molding with a mirror-polished mold has an L value of 0 to 8, the L value being measured with a 0° to 45° spectroscopic color difference meter in conformity with JIS Z 8722.

In one preferable embodiment, the difference of L values of the molded product before and after a weather resistance test measured with a color difference meter is between 0 and 1, the molded product being formed into a plate shape by injection molding with a mirror-polished mold, and the test being in conformity with JIS K 7350-4 and performed for 1,000 hours under the following conditions: black panel 63° C., with rain, and 255 W/m².

### EFFECT OF THE INVENTION

The rubber modified acrylic resin composition of the present invention is excellent in mold-processability, and the molded product thereof is excellent in weather resistance, gloss, jet-blackness, and impact resistance.

### DESCRIPTION OF THE EMBODIMENTS

### Rubber Modified Acrylic Resin Composition

The rubber modified acrylic resin composition of the present invention is a resin composition which includes a rubber modified acrylic resin (A) and a carbon black (B) blended with the resin (A) and which is excellent in jet-blackness. This excellent jet-blackness is an effect specifically exerted by two factors: the rubber modified acrylic resin (A) can provide a 3-mm-thick molded product that has transparency with a total light transmittance of 85% or higher; and the carbon black is dispersed in the resin composition and has a particle diameter of 10 to 40 nm.

### (Rubber Modified Acrylic Resin (A))

As mentioned above, the rubber modified acrylic resin (A) can provide a 3-mm-thick molded product that has transparency with a total light transmittance of 85% or higher. In order to achieve excellent impact strength, 100 parts by weight in total of the resin (A) preferably contains 5 to 100 parts by weight of a rubber-containing acrylic graft copolymer (A1) and 95 to 0 parts by weight of an acrylic resin (A2).

### (Rubber-Containing Acrylic Graft Copolymer (A1))

In order to achieve excellent impact strength and transparency, the rubber-containing acrylic graft copolymer (A1) is preferably a multilayer graft copolymer having an inner layer of a rubber copolymer (A1c) and an outer layer of a graft component (A1s) covering the inner layer with a weight ratio A1c:A1s of 5:95 to 85:15.

In order to achieve higher impact strength, the weight ratio A1c:A1s is more preferably 25:75 to 80:20.

In order to achieve particularly excellent impact strength, the copolymer (A1) is more preferably a multilayer graft copolymer having at least three layers which further has an innermost layer polymer (A1a) with a weight ratio A1a:(sum of A1c and A1s) of 10:90 to 40:60 and which is obtained by polymerizing monomers for the rubber copolymer (A1c) in the presence of this innermost layer polymer (A1a).

From the viewpoint of the balance of impact resistance and transparency, the number average particle diameter of the rubber-containing acrylic graft copolymer (A1) is preferably 30 to 400 nm, and more preferably 40 to 300 nm.

A method of producing such a rubber-containing acrylic graft copolymer (A1) is not particularly limited. Examples thereof include suspension polymerization and emulsion polymerization. The copolymer (A1) is preferably produced by emulsion polymerization because better effects can be achieved by making the particle diameter of copolymer particles uniform.

### (Rubber Copolymer (A1c))

The rubber copolymer (A1c) is a constituent which mainly gives an effect of improving impact resistance owing to its rubber elasticity. The transparency of the resin composition increases as its refractive index becomes closer to those of the graft component (A1s) and the acrylic resin (A2) and its particle size becomes smaller. From the viewpoint of the balance of impact resistance and transparency, the number average particle diameter of such a rubber copolymer (A1c) is preferably 30 to 400 nm, and more preferably 40 to 300 nm.

In order to achieve excellent impact strength and transparency, the rubber copolymer (A1c) is preferably a polymer of 100% by weight of monomers for rubber copolymer containing 50 to 99.9% by weight of an alkyl acrylate, 0 to 49.9% by weight of a copolymerizable vinyl monomer other than the alkyl acrylate, and 0.1 to 10% by weight of a polyfunctional monomer. It is more preferably a polymer of 100% by weight of monomers for rubber copolymer containing 70 to 99% by weight of an alkyl acrylate, 0 to 29% by weight of a copolymerizable vinyl monomer other than the alkyl acrylate, and 0.1 to 5% by weight of a polyfunctional monomer.

### (Graft Component (A1s))

The graft component (A1s) is a constituent serving as a base resin of the composition of the present invention which, together with the acrylic resin (A2), forms a continuous layer resin, namely a matrix resin, encompassing the rubber copolymer (A1c) and the carbon black (B).

In order to achieve excellent impact strength, transparency, and mold-processability, the graft component (A1s) is preferably a polymer of 100% by weight of monomers for graft component containing 50 to 100% by weight of an alkyl methacrylate and 0 to 50% by weight of a copolymerizable vinyl monomer other than the alkyl methacrylate. It is more preferably a polymer of 100% by weight of monomers for graft component containing 80 to 100% by weight of an alkyl methacrylate and 20 to 0% by weight of a copolymerizable vinyl monomer other than the alkyl methacrylate. In order to improve the fluidity of the resin composition of the present invention and further improve the mold-processability thereof, it is preferable to add 0.01 to 5 parts by weight of a mercaptan compound such as dodecyl mercaptan or octyl mercaptan to 100 parts by weight of the monomers for graft component.

This graft component (A1s) itself may be a multilayer component, if necessary.

### (Innermost Layer Polymer (A1a))

The innermost layer polymer (A1a) is a constituent added to the rubber-containing acrylic graft copolymer (A1) for the purpose of further improving the impact strength and transparency of the resin composition of the present invention. It is preferably a polymer of monomers for innermost layer polymer including 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer. The polymer (A1a) is more preferably a polymer of 100% by weight of monomers for innermost layer polymer including 55 to 90% by weight of one or more monomers selected from the group consisting of alkyl methacrylates and aromatic vinyl compounds, 45 to 10% by weight of another copolymerizable vinyl monomer, and 0.1 to 5% by weight of a polyfunctional monomer.

Polymerization of the monomers for the rubber copolymer (A1c) in the presence of this innermost layer polymer (A1a) makes the innermost layer polymer (A1a) be a layer mainly distributed at the center portion of the rubber-containing acrylic graft copolymer (A1).

### (Aromatic Vinyl Compound)

The aromatic vinyl compound is preferably one or more selected from the group consisting of styrene, α-methyl styrene, and vinyl toluene, and is more preferably styrene.

(Alkyl acrylate)

From the viewpoint of the polymerization reaction rate, the alkyl acrylate is preferably one having a C1-C8 alkyl group. Examples thereof include methyl acrylate, ethyl acrylate, propyl acrylate, butyl acrylate (BA), 2-ethylhexyl acrylate (2EHA), and n-octyl acrylate (nOA). In order to improve impact resistance, the alkyl acrylate is preferably one or more selected from the group consisting of BA, 2EHA, and nOA, and is particularly preferably BA. Each of these may be used alone, or two or more of these may be used in combination. The alkyl group in the alkyl acrylate may have a straight chain or may have a branched chain.

### (Alkyl Methacrylate)

From the viewpoint of the polymerization reaction rate, the alkyl methacrylate is preferably one having a C1-C4 alkyl group. Examples thereof include methyl methacrylate, ethyl methacrylate, propyl methacrylate, and butyl methacrylate. In order to improve processability, methyl methacrylate is preferable. The alkyl group in the alkyl methacrylate may have a straight chain or may have a branched chain.

The term “(meth)acrylate” herein means an acrylic acid ester and/or a methacrylic acid ester.

### (Vinyl Monomer)

Examples of the vinyl monomer include aromatic vinyl compounds such as styrene, α-methyl styrene, and vinyl toluene; alkyl(meth)acrylates such as methyl(meth)acrylate, ethyl(meth)acrylate, propyl(meth)acrylate, and butyl(meth)acrylate; non-alkyl(meth)acrylates such as phenyl(meth)acrylate, cyclohexyl(meth)acrylate, and benzyl(meth)acrylate; (meth)acrylonitrile; and (meth)acrylic acid.

### (Polyfunctional Monomer)

The polyfunctional monomer is a monomer having two or more non-conjugated double bonds per molecule, and is a component which serves as a crosslinking agent or a grafting agent. From the viewpoint of crosslinking ability, the polyfunctional monomer is preferably one or more selected from the group consisting of alkylene glycol di(meth)acrylates, vinyl group-containing polyfunctional monomers, and allyl group-containing polyfunctional monomers.

Examples of the alkylene glycol di(meth)acrylates include ethylene glycol di(meth)acrylate, diethylene glycol di(meth)acrylate, dipropylene glycol di(meth)acrylate, and dibutylene glycol di(meth)acrylate.

Examples of the vinyl group-containing polyfunctional monomers include divinylbenzene and divinyl adipate.

Examples of the allyl group-containing polyfunctional monomers include allyl(meth)acrylate, diallyl phthalate, triallyl cyanurate, and triallyl isocyanurate.

### (Acrylic Resin (A2))

The acrylic resin (A2) is a constituent serving as a base resin of the composition of the present invention which, together with the graft component (A1s), forms a continuous layer resin, namely a matrix resin, encompassing the rubber copolymer (A1c) and the carbon black (B). In order to achieve excellent transparency, the resin (A2) is preferably a polymer of monomers for acrylic resin containing 0 to 50% by weight of an alkyl acrylate and 100 to 50% by weight of an alkyl methacrylate.

A method of producing such an acrylic resin (A2) is not particularly limited. Examples thereof include suspension polymerization and emulsion polymerization. In order to efficiently copolymerize an alkyl methacrylate and an alkyl acrylate, suspension polymerization is preferable.

### (Carbon Black (B))

In order to impart sufficient jet-blackness to the rubber modified acrylic resin composition of the present invention, an average particle diameter of the carbon black when it is dispersed in the resin, namely the dispersion particle diameter, needs to be 10 to 40 nm. The dispersion particle diameter is more preferably 10 to 30 nm, further preferably 10 to 25 nm, and most preferably 10 to 20 nm. Carbon black with an average particle diameter larger than 40 nm is not preferable because it fails to impart sufficient jet-blackness. In addition, it is generally difficult to obtain carbon black with an average particle diameter smaller than 10 nm although it has an excellent effect of imparting jet-blackness.

In the present invention, the average particle diameter is determined by observing carbon black aggregates using an electron microscope and measuring the sizes of the components which cannot be separated any more while maintaining their outlines, and calculating the arithmetic mean of the sizes under the condition of N=50 particles.

Carbon black may be supplied in a powder form or in a granulated form. From the viewpoint of the dispersibility of the carbon black, it is preferable to use what is called a masterbatch pigment, which is prepared by preliminarily kneading an acrylic resin and carbon black in high concentration and then pulverizing the kneaded mass, rather than to use the carbon black as it is.

The carbon black is preferably one having a degree of blackness equal to or above that of MCF (medium colour furnace) (that is, HCF: high colour furnace or HCC: high colour channel) which is a general name of colorant carbon black. Examples thereof include, but not limited to, MITSUBISHI Carbon Black (registered trademark) grades #2600, #980, and #960 (Mitsubishi Chemical Corporation); TOKABLACK (registered trademark) grades #8500, #7400, #7350, and #7100 (Tokai Carbon Co., Ltd.); Colour Black (registered trademark) grades FW200, FW2, and S170, and Printex (registered trademark) grades 90 and 80 (Evonik Degussa GmbH); and Raven (registered trademark) grades 7000, 5750, and 3500 (Colombian Chemicals Company), Monarch (registered trademark) grades 1400, 1300, 900, and 800, Black Pearls (registered trademark) grades 1400, 1300, 900, and 800, and Vulcan (registered trademark) grade P (Cabot Corporation).

In order to impart sufficient jet-blackness, the amount of the carbon black is preferably 0.05 parts by weight or more, and more preferably 0.1 parts by weight or more, with respect to 100 parts by weight of the rubber modified acrylic resin (A). Further, the amount is preferably 10 parts by weight or less and more preferably 5 parts by weight or less. Even if more than 10 parts by weight of carbon black is added, the degree of jet-blackness is saturated, resulting in uneconomical use.

### (Ultraviolet Absorber)

In order to further improve weather resistance, the resin composition of the present invention preferably contains an ultraviolet absorber in an amount which does not affect the total light transmittance of the molded product of the resin composition. Namely, the amount thereof is preferably 0.1 to 15 parts by weight, and more preferably 0.2 to 5 parts by weight, with respect to 100 parts by weight of the rubber modified acrylic resin (A).

From the viewpoint of its ultraviolet absorptive power, the ultraviolet absorber is preferably one or more selected from the group consisting of benzotriazole ultraviolet absorbers, triazine ultraviolet absorbers, and benzophenone ultraviolet absorbers.

Examples of the benzotriazole ultraviolet absorbers include 2-(2-hydroxy-5-methylphenyl)benzotriazole, 2-[2-hydroxy-5-(1,1,3,3-tetramethylbutyl)phenyl]benzotriazole, 2-[2-hydroxy-3,5-bis(α,α-dimethylbenzyl)phenyl]benzotriazole, 2-(2′-hydroxy-3-tert-butyl-5′-methylphenyl)-5-chlorobenzotriazole, 2-(2-hydroxy-3,5-di-tert-amylphenyl)benzotriazole, 2-(2-hydroxy-3-sec-butyl-5-tert-butylphenyl)benzotriazole, 2,2′-methylenebis[6-(2H-benzotriazol-2-yl)-4-(1,1,3,3-tetramethylbutyl)phenol], and 2-(2-hydroxy-5-methyl-3-dodecylphenyl)benzotriazole. Examples of the benzophenone ultraviolet absorbers include 2-hydroxy-4-phenylmethoxybenzophenone, 2-hydroxy-4-methoxy-5-sulfoxy trihydrate benzophenone, and 2-hydroxy-4-phenylpropoxybenzophenone. Examples of the triazine ultraviolet absorbers include 2-(4,6-diphenyl-1,3,5-triazin-2-yl)-5-[(hexyl)oxy]-phenol.

### (Light Stabilizer)

In order to further improve weather resistance, the resin composition of the present invention preferably contains a light stabilizer in an amount of 0.1 to 3 parts by weight with respect to 100 parts by weight of the rubber modified acrylic resin (A).

The light stabilizer is not particularly limited and a known light stabilizer may be used. Examples thereof include 2,2,6,6-tetramethyl-4-piperidyl stearate, 2,2,6,6-tetramethyl-4-piperidyl benzoate, 1,2,2,6,6-pentamethyl-4-piperidyl stearate, N-(2,2,6,6-tetramethyl-4-piperidyl)dodecyl succinimide, 1,2,2,6,6-pentamethyl-4-piperidyl benzoate, 1,2,2,6,6-pentamethyl-4-piperidyl methacrylate, bis(2,2,6,6-tetramethyl-4-piperidyl)sebacate, bis(1,2,2,6,6-pentamethyl-4-piperidyl)sebacate, bis(1-octoxy-2,2,6,6-tetramethyl-4-piperidyl)sebacate, bis(2,2,6,6-tetramethyl-4-piperidyl)bis(tridecyl)-1,2,3,4-butanetetracarboxylate, bis(1,2,2,6,6-pentamethyl-4-piperidyl)bis(tridecyl)-1,2,3,4-butanetetracarboxylate, bis(1,2,2,6,6-pentamethyl-4-piperidyl)-2-butyl-2-(3,5-di-tert-butyl-4-hydroxyphenylmethyl)malonate, tetrakis(2,2,6,6-tetramethyl-4-piperidyl)-1,2,3,4-butanetetracarboxylate, tetrakis(1,2,2,6,6-pentamethyl-4-piperidyl)-1,2,3,4-butanetetracarboxylate, 3,9-bis[1,1-dimethyl-2-[tris(2,2,6,6-tetramethyl-4-piperidyloxycarbonyloxy)butylcarbonyloxy]ethyl]-2,4,8,10-tetraoxaspiro[5.5]undecane, 3,9-bis[1,1-dimethyl-2-[tris(1,2,2,6,6-pentamethyl-4-piperidyloxycarbonyloxy)butylcarbonyloxy]ethyl]-2,4,8,10-tetraoxaspiro[5.5]undecane, 1-[(3,5-di-tert-butyl-4-hydroxyphenyl)propionyloxyethyl]-2,2,6,6-tetramethyl-4-piperidyl-(3,5-di-tert-butyl-4-hydroxyphenyl)propionate, a condensate of 1-(2-hydroxyethyl)-2,2,6,6-tetramethyl-4-piperidinol/dimethyl succinate, a condensate of 2-tert-octylamino-4,6-dichloro-s-triazine/N,N′-bis(2,2,6,6-tetramethyl-4-piperidyl)hexamethylenediamine, a condensate of N,N′-bis(2,2,6,6-tetramethyl-4-piperidyl)hexamethylenediamine/dibromoethane, 2,2,6,6-tetramethyl-4-hydroxypiperidine-N-oxyl, a polycondensate of 1,6-bis(2,2,6,6-tetramethyl-4-piperidylamino)hexane/dibromoethane, a polycondensate of 1,6-bis(2,2,6,6-tetramethyl-4-piperidylamino)hexane/2,4-dichloro-6-tert-octylamino-s-triazine, and a polycondensate of 1,6-bis(2,2,6,6-tetramethyl-4-piperidylamino)hexane/2,4-dichloro-6-morpholino-s-triazine.

### (Other Additives)

The resin composition of the present invention may further contain various antioxidants and colorants other than carbon black.

### (Molded Product)

Since the rubber modified acrylic resin composition of the present invention is excellent in mold-processability, it can be formed into automobile components, electric and electronic components, miscellaneous goods, films, and the like by known methods of molding thermoplastic resin, such as injection molding and extrusion molding. The molded product of the present invention thereby obtained is excellent not only in weather resistance, impact resistance, and appearance, but also in jet-blackness and gloss. Therefore, the molded product is suitable for exterior components requiring, for example, luxury appearance. Examples of such external components include components for vehicles, components of household appliances, and films.

The molded product of the present invention formed into a plate shape by injection molding with a mirror-polished mold preferably has an L value of 0 to 8. Here, the L value is measured with a 0° to 45° spectroscopic color difference meter in conformity with JIS Z 8722.

Further, the difference of L values of the plate-shaped molded product before and after a weather resistance test is preferably between 0 and 1. Here, the molded product is formed by injection-molding with a mirror-polished mold, the L values are measured with a color difference meter, and the test is in conformity with JIS K 7350-4 and performed for 1,000 hours under the following conditions: black panel 63° C., with rain, and 255 W/m².

### EXAMPLES

The following will describe the present invention referring to specific examples. These examples are just illustrative ones, and the contents of the present invention are not limited.

(Preparation of Rubber Copolymer A1c-1)

A glass reactor was charged with ion exchange water (250.0 parts by weight), potassium stearate (0.5 parts by weight), sodium formaldehyde sulfoxylate (0.2 parts by weight), disodium ethylenediaminetetraacetate (0.01 parts by weight), and ferrous sulfate heptahydrate (0.005 parts by weight). The substances were heated up to 40° C. while being stirred under nitrogen flow. A mixture of monomers for rubber copolymer including n-butyl acrylate (BA, 84 parts by weight), styrene (ST, 15 parts by weight), and allyl methacrylate (ALMA, 1 part by weight) and cumene hydroperoxide (CHP, 0.1 parts by weight) was dropwise added over 4 hours. At the same time of the dropwise addition, a 5% by weight solution of potassium stearate in water (40 parts by weight, containing 2 parts by weight of potassium stearate) was continuously added over 4 hours. After the addition was finished, stirring was continued for 1.5 hours and the polymerization was terminated. Thereby, latex of a rubber copolymer A1c-1 was obtained. The polymerization conversion was 98% (amount of polymer/amount of monomers×100%). In the obtained latex of the rubber copolymer A1c-1, the rubber copolymer particles had a number average particle diameter of 70 nm (determined by utilizing light scattering at a wavelength of 546 nm).

(Preparation of Rubber Copolymer A1c-2)

Latex of a rubber copolymer A1c-2 was obtained in the same manner as in the aforementioned section (Polymerization of rubber copolymer A1c-1) except that: 0.05 parts by weight of potassium stearate was used instead of 0.5 parts by weight of potassium stearate; monomers for rubber copolymer were prepared from BA (99 parts) and ALMA (1 parts by weight) and a mixture of the monomers for rubber copolymer and cumene hydroperoxide (0.1 parts by weight) was prepared; 10% of this mixture was collectively added and polymerization was allowed to proceed for 1 hour and then the remaining 90% of the mixture was dropwise added over 4 hours; at the same time of the dropwise addition, a 5% by weight solution of potassium stearate in water (30 parts by weight, containing 1.5 parts by weight of potassium stearate) was continuously added over 4 hours; and after the addition was finished, stirring was continued for 1.5 hours and the polymerization was terminated. The polymerization conversion was 97.5% (amount of polymer/amount of monomers×100%). In the obtained latex of the rubber copolymer A1c-2, the rubber copolymer particles had a number average particle diameter of 220 nm (determined by utilizing light scattering at a wavelength of 546 nm).

### (Production of Rubber-Containing Acrylic Graft Copolymers A1-1 to A1-4)

A glass reactor was charged with ion exchange water (220.0 parts by weight), latex of a rubber copolymer shown in Table 1 (solid amount in parts by weight shown in Table 1), sodium formaldehyde sulfoxylate (0.05 parts by weight), disodium ethylenediaminetetraacetate (0.01 parts by weight), and ferrous sulfate heptahydrate (0.005 parts by weight). The substances were stirred under nitrogen flow to prepare an aqueous dispersion, and the dispersion was heated up to 60° C. while its state was maintained. A mixture with a graft composition shown in Table 1, that is, a mixture of monomers for graft component (methyl methacrylate (MMA), BA, and methyl acrylate (MA)), a polymerization initiator (CHP), and normal-dodecyl mercaptan (n-DM), each in amounts (parts by weight) shown in Table 1, was continuously added over 2 hours. After the addition was finished, CHP (0.01 parts by weight) was further added. Stirring was continued for 1 hour and the polymerization was terminated. Thereby, latex of the corresponding rubber-containing acrylic graft copolymer (each of A1-1 to A1-4) was obtained. The polymerization conversion was 99%. The obtained rubber-containing acrylic graft copolymers each had a multilayer structure consisting of an inner layer of the rubber copolymer (A1c) and an outer layer of the graft component (A1s) covering the inner layer. These latexes were solidified by known methods of salting-out, heat-treatment, and drying and thereby formed into white powders. As a result, the corresponding rubber-containing acrylic graft copolymers A1-1 to A1-4 were obtained.

Here, in the production of the latex of the copolymer A1-4, potassium stearate (0.5 parts by weight) was additionally added in the middle of the 2-hour addition, that is, 1 hour after starting the addition, of the mixture with the aforementioned graft composition including the monomers for graft component and the polymerization initiator.

TABLE 1

| | | Rubber-containing acrylic | | | |
|---|---|---|---|---|---|
| | | graft copolymer | | | |
| | | A1-1 | A1-2 | A1-3 | A1-4 |
| Rubber copolymer | A1c-1 | 75 | 75 | 50 | |
| (solid) | A1c-2 | | | | 75 |
| Graft composition | MMA | 20 | 27 | 45 | 20 |
| | BA | 5 | | | 5 |
| | MA | | 3 | 5 | |
| | CHP | 0.05 | 0.05 | 0.1 | 0.05 |
| | n-DM | | | 0.25 | |

### (Production of Three-Layer Rubber-Containing Acrylic Graft Copolymers A1-5 to A1-8)

In order to prepare the innermost layer polymer (A1a), the following process was performed. A glass reactor was charged with ion exchange water (220.0 parts by weight), boric acid (0.3 parts by weight), sodium carbonate (0.03 parts by weight), sodium N-lauroylsarcosinate (0.09 parts by weight), sodium formaldehyde sulfoxylate (0.09 parts by weight), disodium ethylenediaminetetraacetate (0.006 parts by weight), and ferrous sulfate heptahydrate (0.002 parts by weight). The substances were heated up to 80° C. while being stirred under nitrogen flow. Then, a mixed solution for the inner layer component was prepared from monomers for innermost layer polymer shown in Table 2 and t-butyl hydroperoxide (0.1 parts by weight). First, 25% of the solution was collectively charged and polymerization was allowed to proceed for 45 minutes. Next, the remaining 75% of this solution was continuously added over 1 hour. After the addition was finished, the mixture was maintained at a constant temperature for 2 hours and the polymerization was terminated. Thereby, latex of the corresponding three-layer rubber-containing acrylic graft copolymer (each of A1-5 to A1-8) as the innermost layer polymer (A1a) was obtained. Here, during the 1-hour continuous addition of the monomers, sodium N-lauroylsarcosinate (0.2 parts by weight) was additionally added. The obtained latex of the innermost layer polymer (A1a) was a cross-linked methacrylic polymer latex. The polymer particles therein had a number average particle diameter of 160 nm, and the polymerization conversion was 98%. Exceptionally, the innermost layer polymer particles of A1-8 had a number average particle diameter of 135 nm.

In order to prepare the rubber copolymer (A1c), the following process was performed. The aforementioned obtained latex of the innermost layer polymer (A1a) was maintained at 80° C. under nitrogen flow. Potassium persulfate (0.1 parts by weight) was added thereto, and then monomers for rubber copolymer shown in Table 2 were continuously added over 5 hours. During this 5-hour addition, potassium oleate (0.1 parts by weight in total) was added in three portions. After the addition was finished, potassium persulfate (0.05 parts by weight) was further added so as to terminate the polymerization and the mixture was maintained for 2 hours. Thereby, latex of polymer particles having a bilayer structure of the innermost layer polymer (A1a) and the rubber copolymer (A1c) was obtained. The obtained bilayer polymer particles had a number average particle diameter shown in Table 2, and the polymerization conversion was 99% in every case.

In order to prepare the graft component (A1s), the following process was performed. The aforementioned latex of the bilayer polymer particles was kept at 80° C. Potassium persulfate (0.02 parts by weight) was added thereto, and then a mixture with a graft composition shown in Table 2, that is, a mixture containing MMA, BA, and MA, which are monomers for graft component, and n-DM, which is a polymerization initiator, each in an amount shown in Table 2, was continuously added over 2 hours. After the addition of the mixture was finished, the mixture was maintained for 1 hour. Thereby, latex of the corresponding three-layer rubber-containing acrylic graft copolymer (each of A1-5 to A1-8) was obtained. The polymerization conversion was 99% in every case. The latexes of the obtained three-layer rubber-containing acrylic graft copolymers A1-5 to A1-8 were solidified by known methods of salting-out, heat-treatment, and drying, and thereby rubber-containing acrylic graft copolymers A1-5 to A1-8 were obtained as white powders.

TABLE 2

| | | A1-5 | A1-6 | A1-7 | A1-8 |
|---|---|---|---|---|---|
| Monomers for | BA | | 1.25 | 10.5 | 6.3 |
| innermost layer | ST | | | 1.75 | 1.05 |
| polymer | MMA | 24.75 | 23.5 | 12.5 | 7.5 |
| | ALMA | 0.25 | 0.25 | 0.25 | 0.15 |
| Monomers for | BA | 41.5 | 41.5 | 41.5 | 46.2 |
| rubber copolymer | ST | 8 | 8 | 8 | 2.25 |
| | ALMA | 0.5 | 0.5 | 0.5 | 0.55 |
| Average particle size | particle | 230 | 220 | 210 | 200 |
| of bilayer polymer | diameter | | | | |
| particles | (nm) | | | | |
| Graft composition | MMA | 24 | 22.5 | 22.5 | 27 |
| | BA | 1 | 2.5 | | |
| | MA | | | 2.5 | 3 |
| | n-DM | | | | 0.05 |

### (Production of Carbon Black Masterbatch)

In order to improve the dispersibility of the carbon black, carbon black with an average primary particle diameter of 13 nm (40 parts by weight, #2600, Mitsubishi Chemical Corporation), acrylic plastic resin (60 parts by weight, copolymer obtained from 87% by weight of methyl methacrylate and 13% by weight of methyl acrylate, with a melt flow rate of 15 g/10 min (JIS K 7210, 230° C., 37.3 N)), and an antioxidant (0.5 parts by weight, IRGANOX 1010, BASF) were pelletized at 240° C. twice with a 44-mm twin screw extruder and then pulverized. Thereby, a masterbatch (CB-1) of the carbon black was produced.

For the purpose of comparison, a masterbatch (CB-2) of carbon black with an average primary particle diameter of 50 nm (#20, Mitsubishi Chemical Corporation) was prepared in the same manner.

### Examples 1 to 9 and Comparative Examples 1 to 4

The following resins were used as the acrylic resin (A2).

A2-1: copolymer of acrylic resin monomers including 97% by weight of methyl methacrylate and 3% by weight of methyl acrylate, with a melt flow rate of 2.0 g/10 min (JIS K 7210, 230° C., 37.3 N)

A2-2: copolymer of acrylic resin monomers including 87% by weight of methyl methacrylate and 13% by weight of methyl acrylate, with a melt flow rate of 15 g/10 min (JIS K 7210, 230° C., 37.3 N)

The rubber modified acrylic resin (A) including the rubber-containing acrylic graft copolymer (A1) and the acrylic resin (A2) and the carbon black masterbatch, each in an amount (parts by weight) shown in Table 3, were mixed. Further, a benzotriazole ultraviolet absorber TINUVIN 234 (registered trademark) (0.5 parts by weight, BASF), a hindered amine light stabilizer ADK STAB LA-63 (registered trademark) (0.5 parts by weight, ADEKA CORPORATION), and a hindered phenol antioxidant IRGANOX 1010 (registered trademark) (0.5 parts by weight, BASF) were added to prepare a blend. The blend was pelletized at 240° C. using a 44-mm twin screw extruder. This pellet was formed into a 150×150×3 mm plate and a bar. In Comparative Example 4, the carbon black masterbatch was not used. Instead, a Nigrosine dye (NIGROSINE BASE EX, Orient Chemical Industries Co., Ltd.) was used without preparing a masterbatch.

The bar sample thereby obtained was subjected to the Izod impact strength test under the conditions of: ¼ inch, without notch, and 23° C., in conformity with ASTM D 256. Table 3 shows the measurement results.

Further, the degree of jet-blackness was visually observed using the plate sample. Table 3 shows the evaluation results with the symbols ++: very good, +: good, and −: poor (blurred black).

Except that the carbon black masterbatch was not mixed, a sample formed into a 150×150×3 mm plate was prepared in the same manner. The total light transmittance of the plate sample was measured in conformity with JIS K 7361-1, and the transparency was evaluated based on the average transmittance value of the 3-mm-thick molded product within a wavelength range of 380 to 780 nm.

The weather resistance was evaluated as follows. A 150×150×3 mm plate sample was cut into a size of 47×72×3 mm. The sample was subjected to a weather resistance test performed for 2,000 hours using a sunshine carbon arc lamp weather resistance tester (type: WEL-SUN-HCH•B, sunshine super long life weatherometer, Suga Test Instruments Co., Ltd.) under the conditions of: black panel temperature 63° C. and a cycle that water was sprayed for 12 minutes within 60-minute irradiation. The degree of jet-blackness after the weather resistance test was visually evaluated in the same manner as in the evaluation of the initial degree of jet-blackness.

The water resistance was evaluated as follows. The 150×150×3 mm plate sample was cut into a size of 47×72×3 mm. The sample was subjected to a water resistance test in which the sample was immersed in 80° C. pure water for 100 hours. The degree of jet-blackness after the water resistance test was visually evaluated in the same manner as in the evaluation of the initial degree of jet-blackness.

Table 3 shows the compositions in Examples and Comparative Examples, and the evaluation results.

TABLE 3

| | | Example 1 | Example 2 | Example 3 | Example 4 | Example 5 | Example 6 | Example 7 |
|---|---|---|---|---|---|---|---|---|
| Rubber-containing | A1-1 | 20 | | | | | | |
| acrylic graft copolymer | A1-2 | | 20 | | | | | |
| (A1) | A1-3 | | | 30 | | | | |
| | A1-4 | | | | | | | |
| | A1-5 | | | | 20 | | | |
| | A1-6 | | | | | 20 | | |
| | A1-7 | | | | | | 20 | |
| | A1-8 | | | | | | | 20 |
| Acrylic resin (A2) | A2-1 | 50 | 50 | 44 | 50 | 50 | 50 | 50 |
| | A2-2 | 30 | 30 | 26 | 30 | 30 | 30 | 30 |
| Carbon black | CB-1 | 0.5 | 0.5 | 0.5 | 0.5 | 0.5 | 0.5 | 0.5 |
| masterbatch | CB-2 | | | | | | | |
| Nigrosine dye | | | | | | | | |
| Transmittance | % | 90 | 91 | 91 | 90 | 91 | 92 | 91 |
| Degree of | | ++ | ++ | ++ | ++ | ++ | ++ | ++ |
| jet-blackness | | | | | | | | |
| Izod without notch | J/m | 570 | 550 | 560 | 509 | 527 | 530 | 545 |
| Dispersion particle | nm | 30 | 30 | 30 | 30 | 30 | 30 | 30 |
| diameter of carbon black | | | | | | | | |
| Weather resistance | | between | between | between | between | between | between | between |
| | | ++ and + | ++ and + | ++ and + | ++ and + | ++ and + | ++ and + | ++ and + |
| Water resistance | | ++ | ++ | ++ | ++ | ++ | ++ | ++ |

| | | | | Comparative | Comparative | Comparative | Comparative |
|---|---|---|---|---|---|---|---|
| | | Example 8 | Example 9 | Example 1 | Example 2 | Example 3 | Example 4 |
| Rubber-containing | A1-1 | | | | | | |
| acrylic graft copolymer | A1-2 | | | | | | |
| (A1) | A1-3 | | | | | | |
| | A1-4 | | | 20 | | | |
| | A1-5 | | | | | | |
| | A1-6 | 15 | 40 | | 20 | | 20 |
| | A1-7 | | | | | | |
| | A1-8 | | | | | | |
| Acrylic resin (A2) | A2-1 | 50 | 10 | 50 | 50 | 62.5 | 50 |
| | A2-2 | 35 | 50 | 30 | 30 | 37.5 | 30 |
| Carbon black | CB-1 | 0.5 | 0.5 | 0.5 | | 0.5 | |
| masterbatch | CB-2 | | | | 5 | | |
| Nigrosine dye | | | | | | | 0.2 |
| Transmittance | % | 92 | 88 | 60 | 91 | 93 | 90 |
| Degree of | | ++ | ++ | − | − | ++ | ++ |
| jet-blackness | | | | | | | |
| Izod without notch | J/m | 420 | 984 | 535 | 510 | 190 | 525 |
| Dispersion particle | nm | 30 | 30 | 30 | 90 | 30 | — |
| diameter of carbon black | | | | | | | |
| Weather resistance | | between | between | − | − | between | − (color |
| | | ++ and + | ++ and + | | | ++ and + | changed) |
| Water resistance | | ++ | ++ | − | − | ++ | − |
| | | | | | | | (whitened) |

As shown in Table 3, the rubber modified acrylic resin composition of the present invention is excellent in jet-blackness, impact resistance, weather resistance, and moisture resistance (water resistance).

### Examples 10 to 18 and Comparative Examples 5 to 7

Blending in accordance with the composition (parts by weight) shown in Table 4, extrusion with a single screw extruder, molding, and evaluation were performed.

### (Single Screw Extrusion)

A dry-blended mass of the components such as a resin material was extruded with a 40-mm single screw extruder at a die head temperature of 260° C. to provide a strand, and the strand was pelletized using a pelletizer.

### (Injection Molding)

The pellet was molded into a 150×150×3 mm plate (mirror-polished) using an injection molding machine FANUC AUTOSHOT FAS-150B (clamping force: 150 ton) at a nozzle tip temperature of 250° C.

The pellet was molded into a 50×80×2 mm color plate (mirror-polished) using an injection molding machine FN-1000 (Nissei Plastic Industrial Co., Ltd., clamping force: 80 ton) at a nozzle tip temperature of 250° C.

The pellet was molded into an ASTM-standard bar dumbbell using an injection molding machine IS-75E (TOSHIBA CORPORATION, clamping force: 75 ton) at a nozzle tip temperature of 250° C.

The following resins were used.

Acrylic resin 1: ACRYPET VH001 (Mitsubishi Rayon Co., Ltd., catalog values: heat deflection temperature of 100° C. (JIS K 7191, 1.80 MPa), melt flow rate of 2.0 g/10 min (JIS K 7210, 230° C., 37.3 N))

Acrylic resin 2: PARAPET F1000 (KURARAY CO., LTD.)

Acrylic resin 3: DELPET 80NE (Asahi Kasei Chemicals Corporation, catalog values: heat deflection temperature of 97° C. (ISO 75-1, 75-2), melt flow rate of 2.3 g/10 min (ISO 1133 cond 13))

Acrylic resin 4: DELPET 720V (Asahi Kasei Chemicals Corporation, catalog values: heat deflection temperature of 93° C. (ISO 75-1, 75-2), melt flow rate of 21 g/10 min (ISO 1133 cond 13))

Acrylic rubber 1: acrylic modifier Kane Ace M210 (Kaneka Corporation, multilayer rubber particles, core: multilayer acrylic rubber, shell: acrylic polymer mainly containing methyl methacrylate, approximate particle diameter: 220 nm)

### (Carbon Black)

The following was used as carbon black.

Carbon black having an average primary particle diameter of 13 nm (40 parts by weight), the above acrylic resin 2 (59 parts by weight), an antioxidant (IRGANOX 1010, 0.5 parts by weight), and a dispersant (alkyl acid ester, 0.5 parts by weight) were pelletized at 260° C. twice using a 44-mm twin screw extruder, and then the pellet was pulverized. Thereby, carbon black masterbatch (CB-3) was produced.

As a comparative example, SPAB-8K500 (SUMIKA COLOR CO., LTD., carbon concentration: 45%) was used.

### (Other Blending Agents)

In addition to those listed in the blending list, TINUVIN 234 (BASF, benzotriazole ultraviolet absorber), ADK STAB LA-63 (ADEKA CORPORATION, hindered amine light stabilizer), and IRGANOX 1010 (BASF, hindered phenol antioxidant) were used each in an amount of 0.5 parts by weight.

In Examples 16 to 18 and Comparative Example 6, 2,2′-methylenebis(4,6-di-tert-butylphenyl)octyl phosphite (0.3 parts by weight) was blended as a phosphoric stabilizer.

Table 4 shows the results of Examples and Comparative Examples. In Comparative Example 7, a C pillar (black mirror-polished surface), which is an exterior component, of a passenger vehicle MURANO (NISSAN MOTOR CO., LTD.) was used for the measurement.

The total light transmittance was measured using NDH-300A (NIPPON DENSHOKU INDUSTRIES CO., LTD.) in conformity with JIS K 7105.

The degree of jet-blackness was visually observed using the plate sample. The evaluation results were shown with the symbols ++: very good, +: good, and −: poor (blurred black).

A color difference meter SE2000 (NIPPON DENSHOKU INDUSTRIES CO., LTD., in conformity with JIS Z 8722, 0° to 45° spectroscopy, reflection mode, twice on average, opening attachment 30) was used as a color difference meter.

The Lab values were measured using the mirror-polished surfaces of the plate and of the color-plate molded product.

The weather resistance test was performed for 1,000 hours under the conditions of black panel temperature 63° C., with rain, and an irradiation energy of 255 W/m², in conformity with JIS K 7350-4.

The Izod impact strength test (unit: J/m) was performed using the bar sample under the conditions of: ¼ inch, with notch, and 23° C., in conformity with ASTM D 256.

The HDT test (unit: ° C.) was performed using the bar sample at 0.45 MPa in conformity with ASTM D 648.

The MFR test (unit: g/10 min) was performed using the pellet before molding under the conditions of 230° C. and 5 kgf in conformity with ASTM D 1238.

TABLE 4

| | | Example/Comparative Example No. | | | | | | |
|---|---|---|---|---|---|---|---|---|
| | | Example | Example | Example | Example | Example | Example | Example |
| | | 10 | 11 | 12 | 13 | 14 | 15 | 16 |
| Graft copolymer | Acrylic rubber 1 | 15 | 15 | 15 | 15 | 10 | 10 | 15 |
| Acrylic thermoplastic resin | Acrylic resin 1 | 50 | 25 | 12.5 | | 70 | 60 | |
| | Acrylic resin 2 | 35 | 60 | 72.5 | 85 | 20 | 30 | |
| | Acrylic resin 3 | | | | | | | 50 |
| | Acrylic resin 4 | | | | | | | 35 |
| Carbon black | CB-3 (40%) | 0.5 | 0.5 | 0.5 | 0.5 | 0.5 | 0.5 | 0.5 |
| | SPAB-8K500 | | | | | | | |
| | (45%) | | | | | | | |
| Degree of jet-blackness by | | ++ | ++ | ++ | ++ | ++ | ++ | ++ |
| visual observation | | | | | | | | |
| Degree of jet-blackness | L | 5.20 | 5.29 | 5.10 | 5.00 | 5.10 | 5.10 | 5.57 |
| Plate | a | 0.18 | 0.18 | 0.18 | −0.19 | −0.17 | 0.18 | 0.19 |
| Before weather resistance test | b | −1.26 | −1.22 | −1.31 | −1.12 | −0.96 | 1.42 | −1.42 |
| Weather resistance test 1000 h | L | 5.57 | 5.57 | 5.57 | 5.48 | 5.48 | 5.48 | 5.74 |
| | a | 0.19 | −0.13 | 0.19 | −0.14 | 0.19 | 0.19 | −0.11 |
| | b | −1.42 | −1.53 | −1.53 | −1.35 | −1.46 | −1.57 | −1.44 |
| Degree of jet-blackness | L | 5.92 | 5.74 | | | | | 6.00 |
| Color plate | a | −0.10 | −0.11 | | | | | 0.21 |
| Before weather resistance test | b | −1.16 | −1.13 | | | | | −0.33 |
| Weather resistance test 1000 h | L | 6.00 | 5.92 | | | | | 6.24 |
| | a | 0.21 | −0.10 | | | | | −0.07 |
| | b | −1.36 | −1.36 | | | | | −1.51 |
| IZOD | J/m | 32 | 32 | 31 | 27 | 24 | 24 | 26 |
| HDT | ° C. | 101 | 99 | 100 | 99 | 103 | 102 | 101 |
| MFR | g/10 min | 3 | 5 | 7 | 9 | 3 | 3 | 6 |

| | | Example/Comparative Example No. | | | | |
|---|---|---|---|---|---|---|
| | | Example | Example | Comparative | Comparative | Comparative |
| | | 17 | 18 | Example 5 | Example 6 | Example 7 |
| Graft copolymer | Acrylic rubber 1 | 15 | 0 | 20 | 15 | |
| Acrylic thermoplastic resin | Acrylic resin 1 | | | 80 | | |
| | Acrylic resin 2 | | | | | |
| | Acrylic resin 3 | 50 | 60 | | 50 | |
| | Acrylic resin 4 | 35 | 40 | | 35 | |
| Carbon black | CB-3 (40%) | 2.5 | 0.5 | | | |
| | SPAB-8K500 | | | 2.22 | 0.5 | |
| | (45%) | | | | | |
| Degree of jet-blackness by | | + | + | − | − | |
| visual observation | | | | | | |
| Degree of jet-blackness | L | 5.92 | 6.00 | 8.77 | 8.25 | 7.68 |
| Plate | a | 0.10 | −0.39 | −0.31 | −0.15 | 0.03 |
| Before weather resistance test | b | −1.36 | −1.13 | −1.28 | −1.62 | −0.48 |
| Weather resistance test 1000 h | L | 6.08 | | 8.83 | 8.25 | 7.87 |
| | a | −0.08 | | −0.30 | 0.07 | −0.18 |
| | b | −1.39 | | −1.33 | −1.69 | −1.18 |
| Degree of jet-blackness | L | 6.48 | | 9.85 | 9.43 | |
| Color plate | a | −0.05 | | −0.20 | −0.24 | |
| Before weather resistance test | b | −1.40 | | −1.40 | −1.49 | |
| Weather resistance test 1000 h | L | 6.56 | | 9.59 | 9.33 | |
| | a | −0.05 | | −0.23 | −0.25 | |
| | b | −1.46 | | −1.50 | −1.47 | |
| IZOD | J/m | 26 | 14 | 39 | 26 | |
| HDT | ° C. | 100 | 106 | 103 | 101 | |
| MFR | g/10 min | 5 | 8 | 2 | 4 | |

As shown in Examples 10 to 18 in Table 4, in the comparison of the plates, the L values of the rubber modified acrylic resin compositions of the present invention are within the range of about 5.0 to about 6.0, and are significantly lower than the L values shown in Comparative Examples 5 and 6 (within the range of about 8.2 to about 8.8). Therefore, the molded product of the present invention can be considered to have high jet-blackness.

Similarly, in the comparison of the color plates, the L values in Examples 10 to 18 in Table 4 are within the range of about 5.7 to about 6.5, and are significantly lower than the L values in Comparative Examples 5 and 6 (within the range of about 9.4 to about 9.9). Therefore, the molded product of the present invention can be considered to have high jet-blackness. Higher L values of the color plates than the L values of the plates on the whole are probably due to resin orientation on the surface.

The L values in the respective Examples are lower than the L value in Comparative Example 7 (about 7.7), and thus the jet-blackness in Examples can be considered to be high.

As mentioned above, even though the initial L value is low, the difference between the L values before and after the 1,000-hour weather resistance test is 1 or smaller in each Example. Therefore, the molded product of the present invention is found to be excellent not only in a degree of jet-blackness but also in weather resistance.

### Examples 19 to 23 and Comparative Example 8

Blending in accordance with the composition (parts by weight) shown in Table 5, extrusion using a twin screw extruder, molding, and evaluation were performed. The evaluation was performed in the same manner as in Examples 10 to 18 and Comparative Examples 5 to 7.

### (Twin Screw Extrusion)

The blended mass was pelletized using a 44-mm twin screw extruder JSW-TEX 44 at a die head temperature of 260° C. in the same manner as in the case of single screw extrusion.

Table 5 shows the results of Examples and Comparative Examples. In Comparative Example 8, an A pillar (black mirror-polished surface), which is an exterior component, of a Mini Cooper produced by BMW group was used for the measurement. Further, the A pillar was shaved off and a small amount of the shaved matter was immersed in methanol, resulting in that a red to purple colored component was extracted. Thus, the pillar was found to be colored by a dye. The IR spectrum of this methanol-soluble component well corresponded to the IR spectrum of an anthraquinone-based dye. In addition, a small amount of this shaved matter was dissolved in THF, and the soluble component was casted on a KBr plate. The IR spectrum measured in this case well corresponded to the IR spectrum of PMMA resin. Observation of this matter using a TEM (transmission electron microscope) showed that no rubber particles such as acrylic rubber components existed.

TABLE 5

| | | Example/Comparative Example No. | | | | | |
|---|---|---|---|---|---|---|---|
| | | Example | Example | Example | Example | Example | Comparative |
| | | 19 | 20 | 21 | 22 | 23 | Example 8 |
| Graft copolymer | Acrylic rubber 1 | 15 | 15 | 30 | 40 | 40 | |
| Acrylic thermoplastic resin | Acrylic resin 3 | 50 | 0 | 20 | 10 | 0 | |
| | Acrylic resin 4 | 35 | 85 | 50 | 50 | 60 | |
| Carbon black | CB-3 (40%) | 0.5 | 0.5 | 0.5 | 0.5 | 0.5 | |
| Degree of jet-blackness by | | ++ | ++ | ++ | + | + | ++ |
| visual observation | | | | | | | |
| Degree of jet-blackness | L | 5.66 | 5.29 | 5.66 | 5.74 | 5.74 | 4.24 |
| Plate | a | −0.12 | 0.18 | −0.12 | −0.11 | −0.11 | 0.15 |
| Before weather resistance test | b | −1.06 | −1.11 | −1.27 | −1.34 | −1.34 | −1.08 |
| Weather resistance test 1000 h | | 5.74 | 5.57 | 5.83 | 6.00 | 5.92 | 5.39 |
| | | 0.20 | −0.13 | −0.11 | −0.09 | 0.20 | 0.52 |
| | | −1.34 | −1.21 | −1.30 | −1.52 | −1.36 | −1.84 |
| Degree of jet-blackness | L | 6.40 | 5.92 | 6.63 | 7.14 | 7.28 | |
| Color plate | a | −0.34 | −0.10 | −0.04 | 0.00 | 0.01 | |
| Before weather resistance test | b | −1.16 | −1.06 | −1.43 | −1.72 | −1.74 | |
| Weather resistance test 1000 h | | 6.32 | 5.92 | 6.24 | 6.40 | 6.48 | |
| | | −0.06 | 0.20 | 0.21 | −0.06 | 0.22 | |
| | | −1.38 | −1.36 | −1.32 | −1.34 | −1.31 | |
| IZOD | J/m | 25 | 25 | 47 | 61 | 63 | |
| HDT | ° C. | 102 | 100 | 99 | 98 | 96 | |
| MFR | g/10 min | 6 | 19 | 6 | 4 | 6 | |

With respect to the plates, as shown in Examples 19 to 23 in Table 5, the L values of the rubber modified acrylic resin compositions of the present invention are within the range of about 5.2 to about 5.8. With respect to the color plates, the L values are within the range of about 5.9 to about 7.3. Therefore, the resin composition and the molded product of the present invention are considered to have high jet-blackness regardless of the melt kneading methods.

As mentioned above, the difference between the L values before and after the 1,000-hour weather resistance test is 1 or smaller even though the initial L value is low in each Example. Therefore, the molded product of the present invention is found to be excellent not only in a degree of jet-blackness but also in weather resistance. In contrast, in Comparative Example 8, the difference between the L values before and after the 1,000-hour weather resistance test is greater than 1 even though the initial L value is low. Therefore, the weather resistance is poor.

1. A jet-black rubber modified acrylic resin composition comprising:
100 parts by weight of a rubber modified acrylic resin (A); and
0.05 to 5 parts by weight of a carbon black (B) blended with the resin (A) by means of melt kneading,
the rubber modified acrylic resin (A) being capable of providing a 3-mm-thick molded product that has transparency with a total light transmittance of 85% or higher, and
the carbon black being dispersed in the resin composition with a dispersion particle diameter of 10 to 40 nm.

2. The rubber modified acrylic resin composition according to claim 1,
wherein 100 parts by weight of the rubber modified acrylic resin (A) contains 5 to 100 parts by weight of a rubber-containing acrylic graft copolymer (A1) and 95 to 0 parts by weight of an acrylic resin (A2);
the rubber-containing acrylic graft copolymer (A1) is a multilayer graft copolymer having an inner layer of a rubber copolymer (A1c) and an outer layer of a graft component (A1s) with a weight ratio (A1c:A1s) of 5:95 to 85:15, the outer layer covering the inner layer;
the rubber copolymer (A1c) is a polymer of 100% by weight of monomers for rubber copolymer containing 50 to 99.9% by weight of an alkyl acrylate, 0 to 49.9% by weight of another copolymerizable vinyl monomer, and 0.1 to 10% by weight of a polyfunctional monomer;
the graft component (A1s) is a polymer of 100% by weight of monomers for graft component containing 50 to 100% by weight of an alkyl methacrylate and 0 to 50% by weight of a copolymerizable vinyl monomer other than the alkyl methacrylate; and
the acrylic resin (A2) is a polymer of monomers for acrylic resin containing 0 to 50% by weight of an alkyl acrylate and 100 to 50% by weight of an alkyl methacrylate.

3. The rubber modified acrylic resin composition according to claim 2,
wherein the rubber-containing acrylic graft copolymer (A1) has a number average particle diameter of 30 to 400 nm.

4. The rubber modified acrylic resin composition according to claim 2,
wherein the rubber-containing acrylic graft copolymer (A1) is a multilayer graft copolymer which has at least three layers, which further has an innermost layer polymer (A1a) with a weight ratio (A1a:(sum of A1c and A1s)) of 10:90 to 40:60, and which is obtained by polymerization of the monomers for rubber copolymer in the presence of the innermost layer polymer (A1a); and
the innermost layer polymer (A1a) is a polymer of 100% by weight of monomers for innermost layer polymer containing 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer.

5. A molded product, which is prepared by molding the rubber modified acrylic resin composition according to claim 1.

6. The molded product according to claim 5,
wherein the molded product formed into a plate shape by injection molding with a mirror-polished mold has an L value of 0 to 8, the L value being measured with a 0° to 45° spectroscopic color difference meter in conformity with JIS Z 8722.

7. The molded product according to claim 6,
wherein the difference of L values of the molded product before and after a weather resistance test measured with a color difference meter is between 0 and 1,
the molded product being formed into a plate shape by injection molding with a mirror-polished mold, and
the test being in conformity with JIS K 7350-4 and performed for 1,000 hours under the following conditions: black panel 63° C., with rain, and 255 W/m².

8. The rubber modified acrylic resin composition according to claim 3,
wherein the rubber-containing acrylic graft copolymer (A1) is a multilayer graft copolymer which has at least three layers, which further has an innermost layer polymer (A1a) with a weight ratio (A1a:(sum of A1c and A1s)) of 10:90 to 40:60, and which is obtained by polymerization of the monomers for rubber copolymer in the presence of the innermost layer polymer (A1a); and
the innermost layer polymer (A1a) is a polymer of 100% by weight of monomers for innermost layer polymer containing 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer.

9. A molded product, which is prepared by molding the rubber modified acrylic resin composition according to claim 2.

10. A molded product, which is prepared by molding the rubber modified acrylic resin composition according to claim 3.

11. A molded product, which is prepared by molding the rubber modified acrylic resin composition according to claim 4.

12. The rubber modified acrylic resin composition according to claim 1,
which is prepared by using a carbon black masterbatch containing the carbon black.
